(19) United States
(12) Patent Application Publication
(10) Pub. No.: US 2007/0090284 A1
(43) Pub. Date: Apr. 26, 2007

(54) Image sensor package structure

(76) Inventors: Mon Nan Ho, Hsinchu Hsien (TW); Chen Pin Peng, Hsinchu Hsien (TW); May Chen, Hsinchu Hsien (TW); Eric Lin, Hsinchu Hsien (TW)

Correspondence Address: PRO-TECHTOR INTERNATIONAL SERVICES, 20775 NORADA CT., SARATOGA, CA, 95070, US

(21) Appl. No.: 11/256,366

(22) Filed: Oct. 20, 2005

(51) Int. Cl. H01J 5/02

(52) U.S. Cl. 250/239

(57) ABSTRACT

An image sensor package structure includes a substrate having an upper surface, which is formed with equal amount of the first electrodes arranged at the each side of the upper surface, each the first electrode of the adjacent side of the substrate is corresponding electrically connected each other, so that the signal from one side of the substrate may be transmitted the adjacent side, the each side of the lower surface of the substrate is formed with second electrodes, each side of the second electrodes is less than the each side of the first electrodes of the upper surface, then the second electrode is electrically connected to the first electrode, so that the signal from the first electrode may be directly transmitted to the second electrode and through adjacent one side of the first electrode transmitted to the second electrode. A frame layer is arranged at the upper surface of the substrate. A chip is mounted at the upper surface of the substrate a, at least one side of the chip is formed with bonding pads, which are equal or not many than the first electrodes of the one side of the substrate. Wires are electrically connected the pads of the chip to the first electrodes of the substrate. A transparent layer is covered on the frame layer to encapsulate the chip.

### BACKGROUND OF THE INVENTION

1. Field of the Invention

The invention relates t an image sensor package structure, and particular to a structure for packaging different size chip, the manufacturing cost may be decreased, and the reliability of the image sensor may be promoted.

2. Description of the Related Art

Referring to FIG. 1, it is an image sensor structure includes a substrate 10, a frame layer 18, a photosensitive chip 26, a plurality of wires 28, and a transparent layer 34.

The substrate 10 has a first surface 12 on which plurality of first electrodes 15 are formed, and a second surface 14 on which plurality of second electrodes 16 are formed. The first electrodes 15 are corresponding to electrically connect to the second electrodes 16 by the conductive wires 17, which are located at the side of the substrate. The frame layer 18 has an upper surface 20 and a lower surface 22 adhered to the first surface 12 of the substrate 10 to form a cavity 24 together with the substrate 10. The photosensitive chip 26 is arranged within the chamber 24, and is mounted to the first surface 12 of the substrate 10. Each wire 28 has a first terminal 30 and a second terminal 32. The first terminals 30 are electrically connected to the photosensitive chip 26, and the second terminals 32 are electrically connected to the first electrodes 15 of the substrate 10. The transparent layer 34 is adhered to the upper surface 20 of the frame layer 18.

Please referring to FIG. 2, when the pads of the chip is located on the two side of the chip, the first electrode of the substrate must arranged at the two side of the substrate, so that the conventional substrate can not use.

### SUMMARY OF THE INVENTION

An objective of the invention is to provide an image sensor package structure, and capable of decreasing the manufacturing cast of the image sensor.

An objective of the invention is to provide an image sensor package structure, and capable of increasing the reliability of the image sensor package.

To achieve the above-mentioned object, the invention provides includes a substrate having an upper surface, which is formed with equal amount of the first electrodes arranged at the each side of the central region, each the first electrode of the adjacent side of the substrate is corresponding electrically connected each other, so that the signal from one side of the substrate may be transmitted to the adjacent side, the each side of the lower surface of the substrate is formed with second electrodes, each side of the second electrodes is less than the each side of the first electrodes of the upper surface, then the second electrode is electrically connected to the first electrode, so that the signal from the first electrode may be directly transmitted to the second electrode and through adjacent one side of the first electrode transmitted to the second electrode. A frame layer is arranged at the upper surface of the substrate. A chip is mounted at the upper surface of the substrate a, at least one side of the chip is formed with bonding pads, which are equal or not many than the first electrodes of the one side of the substrate. Wires are electrically connected the pads of the chip to the first electrodes of the substrate. A transparent layer is covered on the frame layer to encapsulate the chip.

### BRIEF DESCRIPTION OF THE DRAWINGS

FIG. 1 is a schematic illustration showing a conventional image sensor structure.

FIG. 2 is a top-view illustration showing a top view of a conventional image sensor package.

FIG. 3 is a schematic illustration showing an image sensor package structure of the present invention.

FIG. 4 is a top view of the substrate of an image sensor package structure of the present invention.

FIG. 5 is a top view of an image sensor package structure of the present invention.

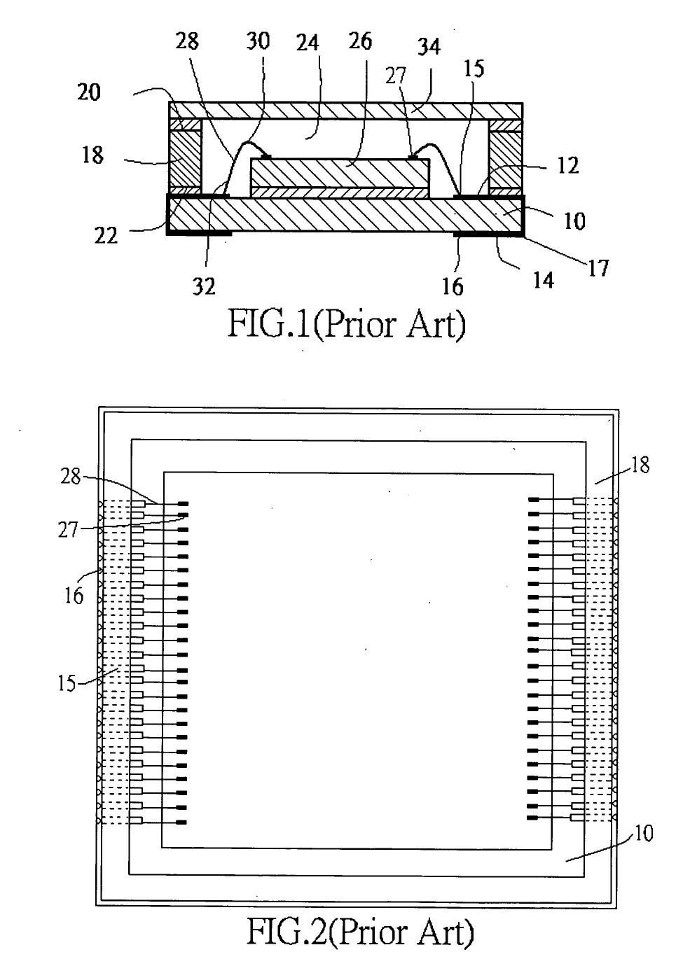

### DETAILED DESCRIPTION OF THE INVENTION

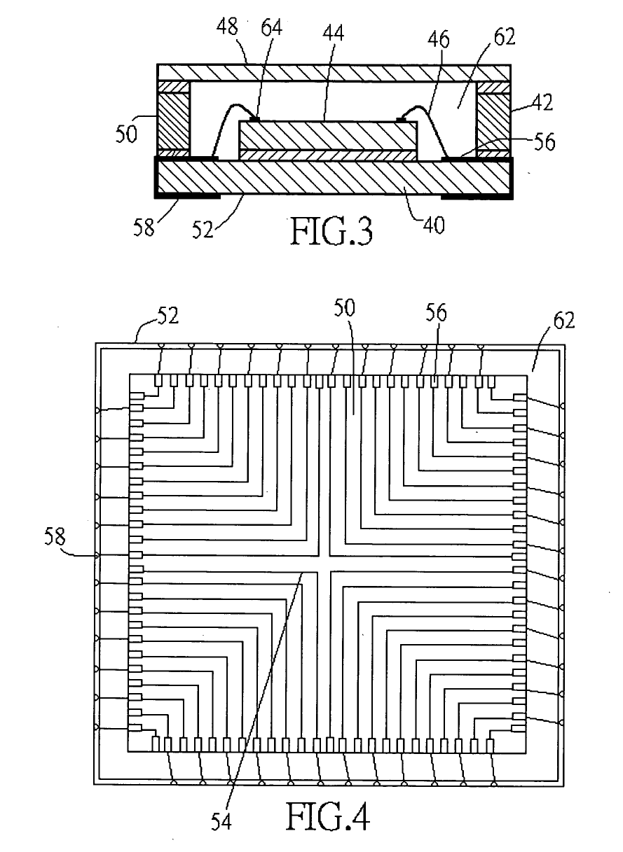

Please refer to FIG. 3, an image sensor package structure of the present invention includes substrate 40, a frame layer 42, a chip 44, wires 46, and transparent layer 48.

Please refer to FIG. 4. The substrate 40 has an upper surface 50, which is formed with a central region 54 and equal amount of the first electrodes 56 arranged at the each side of central region 54, each the first electrode 56 of adjacent side is corresponding electrically connected, so that the signal from one side of the substrate 40 may be transmitted to the adjacent side, and a lower surface 52. Each side of the lower surface 52 of the substrate 40 is formed with second electrodes 58, each side of the second electrodes 58 is less than the each side of the first electrodes 56 of the upper surface 50 of the substrate 40, then the second electrodes 58 are electrically connected to the first electrodes 56, so that the signal from the first electrodes 56 may be directly transmitted to the second electrodes 58 and through adjacent one side of the first electrodes 56 transmitted to the second electrode 58.

In the embodiment, the each one side of the central region 54 of the substrate 40 is formed with twenty-four first electrodes 56. One side of the lower surface 54 of the substrate 40 is formed with twelve second electrodes.

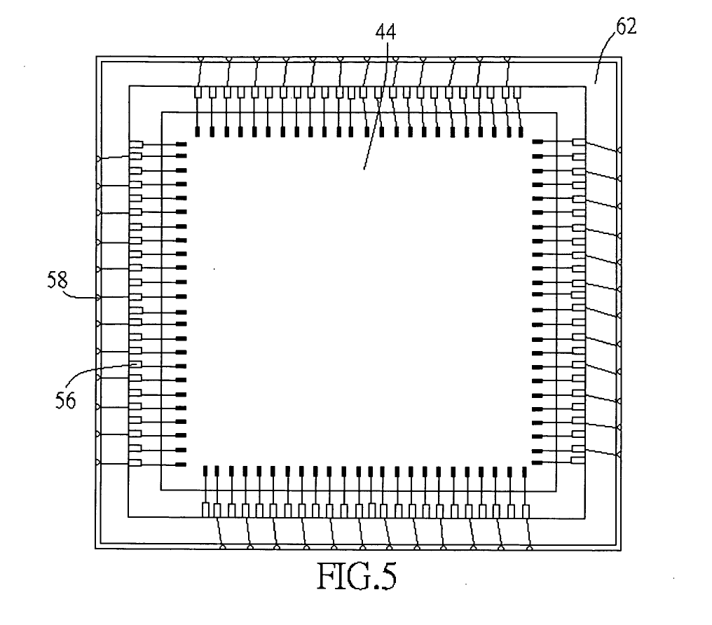

Please refer to FIG. 5. The frame layer 42 is arranged at the upper surface 50 of the substrate 40, a cavity 62 is formed between with substrate 40 and frame layer 42.

The chip 44 is mounted at the central region 54 of the upper surface 50 of the substrate 40 and is located within the cavity 62, each side of the chip 44 is formed with bonding pads 64, which are equal or not many than the first electrodes 56 of the one side of the substrate 40, in the embodiment, wherein each side of the chip 44 is formed with twenty-four bonding pads 64.

The plurality of wires 46 are electrically connected the bonding pads 64 of the chip 44 to the first electrodes 56 of the substrate 40, so that the signal from the chip 44 is transmitted to the second electrodes 58 of the substrate 40 through the first electrodes 56.

The transparent layer 48 is covered on the frame layer 42 to encapsulate the chip 44.

Therefore, the signal from the chip 44 may be transmitted to the second electrodes 58 through the first electrodes 56 formed at the each side of the upper surface 50.

While the invention has been described by the way of an example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. An image sensor package structure, the structure comprising;
a substrate having an upper surface, which is formed with a central region and equal amount of the first electrodes arranged at the each side of the central region, each the first electrode of adjacent side is corresponding electrically connected, so that the signal from one side of the substrate may be transmitted to the adjacent side, each side of the lower surface of the substrate formed with second electrodes, each side of the second electrodes is not many than the each side of the first electrodes of the upper surface, then the second electrode is electrically connected to the first electrode, so that the signal from the first electrode may be directly transmitted to the second electrode and through adjacent one side of the first electrode transmitted to the second electrode;
a frame layer arranged at the upper surface of the substrate, a cavity formed between with substrate and frame layer;
a chip mounted at the central region of the upper surface of the substrate and located within the cavity, at least one side of the chip formed with bonding pads, which are equal or less than the first electrodes of the one side of the substrate;
a plurality of wires electrically connected the bonding pads of the chip to the first electrodes of the substrate, so that the signal from the chip transmitted to the second electrodes of the substrate through the first electrodes; and
a transparent layer covered on the frame layer to encapsulate the chip.

2. The image sensor package structure according to claim 1, wherein the each one side of the central region of the substrate is formed with twenty-four first electrodes.

3. The image sensor package structure according to claim 1, wherein at least one side of the chip is formed with twenty-four bonding pads.

4. The image sensor package structure according to claim 1, wherein the one side of the lower surface of the substrate is formed with twelve second electrodes.
